(19) United States
(12) Patent Application Publication
(10) Pub. No.: US 2004/0256925 A1
(43) Pub. Date: Dec. 23, 2004

(54) Rectifier for a vehicle alternator

(75) Inventors: Gary Morrissette, Groveland, FL (US); An Huu Nguyen, Orlando, FL (US)

Correspondence Address: RICHARD K. WARTHER, ALLEN, DYER,DOPPELT,MILBRATH & GILCHRIST P.A., 1401 CITRUS CENTER 255 SOUTH ORANGE AVENUE, P.O. BOX 3791, ORLANDO, FL, 32802-3791, US

(73) Assignee: Transpo Electronics, Inc., Orlando, FL

(21) Appl. No.: 10/464,813

(22) Filed: Jun. 18, 2003

(51) Int. Cl. H02K 11/00

(52) U.S. Cl. 310/68 B; 310/68 R

(57) ABSTRACT

A vehicle alternator includes front and rear housing members, a Y-connected stator coil and rotor supported by the front and rear housing members, and a rear cover that connects to the rear housing member. A brush holder and rectifier are disposed on the rear housing member and interposed between the rear housing member and rear cover. The rectifier is operatively connected to the Y-connected stator coil. The rectifier includes negative and positive heat sinks having pressed fit diodes received within diode openings. Positive and negative heat sinks are less than five millimeters thick, in one aspect of the present invention. A lead frame is formed of an insulator material and mounted on a side of the positive heat sink opposite the negative heat sink. The lead frame includes embedded conductors and connectors that interconnect diode leads of the rectifier diodes in an electrical rectifying configuration.

### FIELD OF THE INVENTION

This invention relates to the field of rectifiers, and more particularly, this invention relates to rectifiers having heat sinks and rectifier diodes and used for vehicle alternators.

### BACKGROUND OF THE INVENTION

One common type of vehicle alternator is disclosed in U.S. Pat. No. 5,694,313, issued Dec. 2, 1997, assigned to Nippondenso Company, Ltd., the disclosure which is hereby incorporated by reference in its entirety. This type of alternator includes a Y-connected stator coil and rotor supported by front and rear housing members. A brush holder and rectifier are disposed on the outer surface of the rear housing member at the rear of the alternator and interposed between the rear housing member and a rear cover. Usually, a rectifier used on this type of vehicle alternator must be limited in size because it is interposed between the rear housing member and the rear cover. Size is critical in modern automobile applications and these type of alternator designs and any rectifier design must take into consideration these design constraints.

The rectifier uses for these types of Nippondenso alternators generally includes a negative and positive heat sink (also termed fins), which are formed very thin to save space in the axial direction of the alternator. The heat sinks used in these Nippondenso and similar alternator applications are formed of copper plate material, for example, and typically have a thickness less than 5 millimeters. A lead frame is formed from an insulator material and mounted on the positive heat sink opposite the negative heat sink instead of being interposed between the heat sinks, as is typical on other rectifier designs, such as disclosed in published patent application number 2002/0140300 assigned to Denso Corporation. Other designs also are designed with the lead frame on the outside (and not interposed between heat sinks), and have used pressed fit diodes, but these rectifiers have had thick heat sinks made of thicker aluminum (instead of copper) or greater than 5 millimeters, such as disclosed in U.S. Pat. No. 6,476,527. Press fitting diodes into thin heat sinks has not been considered practical. The heat sinks disclosed in the '527 patent also are more square in configuration instead of semicircular in configuration, as used in many Nippondenso alternator applications. The design of a lead frame on the side opposing heat sinks (not interposed between) also can save space in the axial direction of the alternator. The lead frame has embedded conductors and connectors that interconnect rectifier diodes pointing in the same direction and in an electrical rectifying configuration. A terminal bolt, either vertical or horizontal, is connected to the positive heat sink.

As disclosed in the '313 patent, the heat sinks in these rectifiers for these Nippondenso alternators include concave diode receiving portions that are formed on the surface of the heat sinks as “dish” indentations. Potted diodes are soldered or the surface of the heat sinks (or input fins) at the concave diode receiving portions. Diode leads are connected to terminal strips or connectors formed on the lead frame. The concave diode receiving portions on each heat sink form slight indentations on the surface of the heat sink where the potted diodes are mounted and soldered. These potted diodes are also referred to as “dish” diodes because they are soldered onto the surface of the heat sink in an area of the heat sink resembling a dish, i.e., the concave diode receiving portion. This type of design is commonly used in many rectifiers for vehicle alternators of the type described.

In high performance applications, including racing applications, the potted or “dish” type diode rectifiers do not last for extended periods of time and fail early. It would be desirable to mount the diodes to the heat sinks in a more advantageous manner and prolong the life of the rectifier and diodes, especially in the Nippondenso and similar vehicle alternator designs that heretofore have always used potted diodes, and thus, extend the working life of the vehicle alternator.

### SUMMARY OF THE INVENTION

The present invention advantageously uses pressed fit diodes in a vehicle alternator, such as a Nippondenso alternator as described, which had not previously been used because it was commonly held by many skilled in the art that pressed fit diodes were unworkable and add greater expense to the rectifiers designed for use in such alternator applications. The rectifier diodes are pressed fit within diode openings of the negative and positive heat sinks. The use of pressed fit diodes overcomes the disadvantages of prior art alternators as described above, e.g., Nippondenso and similarly designed vehicle alternators having limited thickness heat sinks designed for the close confines of the vehicle alternators.

In accordance with the present invention, a rectifier for a vehicle alternator of the present invention includes a negative heat sink having a thickness less than 5 millimeters and having a plurality of diode openings. A positive heat sink has a thickness less than 5 millimeters and has a plurality of diode openings. The positive heat sink is mounted in parallel, spaced relation to the negative heat sink. Rectifier diodes are pressed fit within respective diode openings of the negative and positive heat sinks. A lead frame is formed of an insulator material and mounted on the positive heat sink opposite the negative heat sink such that the lead frame is not interposed between the heat sinks. The lead frame includes embedded conductors and connectors that interconnect rectifier diodes in an electrical rectifying configuration.

In one aspect of the present invention, an annular shoulder is formed around each diode opening for supporting a rectifier diode in a pressed fit within a respective diode opening. This helps strengthen the weaker heat sink pressed fit connection due to the thin heat sink. A terminal bolt is connected to the positive heat sink. The terminal bolt could be horizontal or vertical to the axial direction of the rectifier. A plurality of input terminals are adapted to be connected to a stator coil, which typically is a Y-connected stator coil. The positive heat sink includes a mounting flange along an arcuate edge. It includes cut-outs for exposing the input terminals and allowing connection to a stator coil. The input terminals are formed integral with the lead frame.

In yet another aspect of the present invention, the heat sinks are substantially semicircular configured and have a thickness ranging from about 1-3 millimeters. The lead frame is also semicircular configured and extends along the curve defined by the positive heat sink. A plurality of insulated rivets interconnect and secure together the heat sinks and lead frame, while separating the heat sinks from each other in spaced, electrically floating relation The positive heat sink preferably has a greater surface area than the negative heat sink, exposing the rectifying diodes pressed fit within the diode openings of the positive heat sink.

In yet another aspect of the present invention, the vehicle alternator of the present invention has front and rear housing members. A Y-connected stator coil and rotor are supported by the front and rear housing member. A rear cover is connected to the rear housing member. A brush holder and rectifier are disposed on the rear housing member and interposed between the rear housing member and the rear cover. The rectifier is operatively connected to the Y-connected stator coil. This rectifier includes the negative and positive heat sinks with pressed fit diodes, and the secured lead frame.

A method of forming a rectifier used for a vehicle alternator is also set forth. The method includes the step of forming positive and negative heat sinks having a thickness less than 5 millimeters. Diode openings are formed within each of the positive and negative heat sinks. Rectifier diodes are pressed fit within respective diode openings. A lead frame having embedded conductors and connectors is mounted on the positive heat sink opposing the negative heat sink. The lead frame and heat sinks are secured together in spaced, substantially parallel relation. The diodes are interconnected to connectors on the lead frame, such as by solder. The rectifier diodes are configured in an electrically rectifying configuration. Because the heat sinks are small, a shoulder is formed around each diode opening for supporting the rectifier in a pressed fit within the diode opening.

### BRIEF DESCRIPTION OF THE DRAWINGS

Other objects, features and advantages of the present invention will become apparent from the detailed description of the invention, which follows, when considered in light of the accompanying drawings in which:

FIG. 1 is a plan view of a prior art Nippondenso vehicle alternator, and showing a rectifier with negative and positive heat sinks, including a concave or “dish” indentation to receive a potted diode that is soldered onto the heat sink, and a portion of a cover that can be secured to the rear housing member of the alternator.

FIG. 2 is a plan view of a rectifier of the present invention looking down at the positive heat sink and its lead frame.

FIG. 3 is a plan view of the rectifier of the present invention and showing the negative heat sink and the arcuate, peripheral edge of the positive heat sink.

FIG. 4 is a side elevation view looking in the direction of the arrow in FIG. 3 and showing the positive and negative heat sinks spaced from each other and secured together by insulating rivets.

FIG. 5 is a side elevation view looking in the direction of arrow 5 of FIG. 3 and showing the positive and negative heat sinks spaced from each other.

FIG. 6 is an exploded isometric view of a positive heat sink and showing a horizontal terminal bolt to be connected to the positive heat sink.

FIG. 7 is an isometric view in assembled form of the positive heat sink shown in FIG. 6.

FIG. 8 is an exploded isometric view of another embodiment of a positive heat sink and showing a vertical terminal bolt.

FIG. 9 is an isometric view of the positive heat sink of FIG. 8 in an assembled form.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The present invention advantageously overcomes the disadvantages of prior art rectifiers used in Nippondenso and similarly designed vehicle alternators that use Y-connected or similarly configured stator coils and rotors supported by front and rear housing members, such as disclosed in the incorporated by reference '313 patent. These types of alternators are designed to fit rectifiers into areas that are limited in space. Brush holders and rectifiers are disposed on the rear housing member and interposed between the rear housing member and a rear cover. The rectifiers use thin heat sinks, typically less than 5 millimeters thick, and potted or dish type diodes secured by soldering into concave diode receiving portions or dish indentations formed on the surface of the heat sinks. Pressed fit diodes have not been used with these type of rectifiers and vehicle alternators because the potted diodes were considered easier to manufacture and assemble with the vehicle alternator and-considered more stable. Engineers and designers had not considered the use of pressed fit diodes in a rectifier and alternator design of this type. By using pressed fit diodes with the positive and negative heat sinks, it has been found, to the surprise of many skilled in the art, that the diodes are now able to withstand greater stresses and heat, and as a result, the rectifiers last longer in these types of alternator designs, such as the Nippondenso alternator as described.

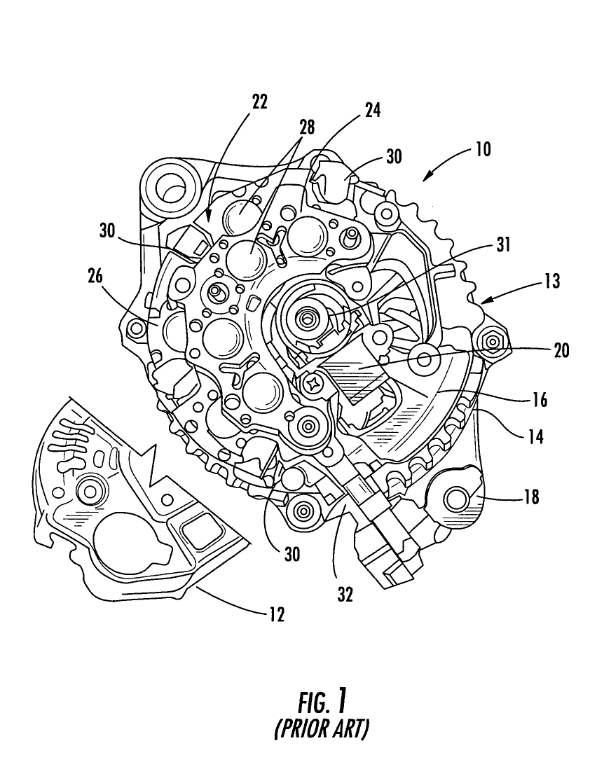

FIG. 1 is a plan view of a prior art vehicle alternator 10 manufactured by Nippondenso Company, Ltd. of Kariya, Japan, such as the type disclosed in the incorporated by reference '313 patent. This view looks toward the rear of the alternator. The rear cover 12 is removed and a fragment of the cover 12 for illustration purposes only is shown lying next to the alternator 10. This alternator includes a housing 13 formed from front and rear housing members 14, 16. The front housing member 14 typically includes mounting flanges 18 for securing the alternator to a vehicle engine. Other related alternator components, including air vents, are shown but not described in detail here. A Y-connected stator coil and rotor (not shown in detail) are supported by front and rear housing members 14, 16. The rear cover 12 connects to the rear housing member 16. A brush holder 20 and rectifier 22 are disposed on the rear housing member and interposed between the rear housing member and rear cover 12 when the rear cover is secured. These components are mounted on the rear housing member by means known to those skilled in the art. The rectifier 22 is operatively connected to the Y-connected stator coil.

As illustrated, the rectifier 22 includes a negative heat sink 24 and a positive heat sink 26. The heat sinks 24, 26, also referred to as fins by some skilled in the art, and are formed of thin copper typically, less than 5 millimeters thick and about 1-3 millimeters thick in one embodiment. The heat sinks are substantially semicircular, about 180° in configuration. Each heat sink includes four concave receiving portions, each formed as dish indentations 28, which receive potted rectifier diodes (not shown in this view because they are positioned on the other side of the heat sink), for example, described in the incorporated by reference '313 patent. The diodes are soldered and interconnected by a lead frame formed of an insulator material mounted on the positive heat sink 26, such that lead frame terminals 30 formed on the lead frame can be connected to stator outputs. The heat sinks 24, 26 and lead frame are secured together by insulated rivets 32, which also receive mounting bolts 34 fixed on the rear housing member 16 for fixing the rectifier onto the rear housing member.

This type of Nippondenso alternator typically has a rotor, a Y-connected stator, and a housing split into the front and rear housing members 14, 16 and formed by die casting aluminum. The rotor is driven by a vehicle engine to generate electric power and charge a vehicle battery while also supplying power to an electrical load. The rotor rotates integral with a rotor shaft 31. This type of Nippondenso alternator may include a Lundell type pole core, a field coil, and slip rings, such as disclosed in the '313 patent. Cooling fans are situated in the front and rear housing members of the alternator. The stator is usually formed as a stator core disposed around an outer periphery of a pole core. A three-phase Y-connected stator coil is wound in the stator core. Three-phase alternating current is supplied from output ends and neutral points of the Y-connected stator coil, and respectively connected to input terminals of the rectifier. The rectifier 10 is grounded and the negative heat sink 24 is typically connected to the rear cover 12. Potted diodes are positioned and interconnected by the lead frame for three-phase rectification and a neutral connection for a Y-connection is supplied. Four potted diodes are soldered on each heat sink.

As shown in FIG. 1, a terminal bolt assembly 32 is connected to the positive heat sink 26 and connects to other vehicle components. A voltage regulator can also be interposed on the rear housing member 16 of the alternator.

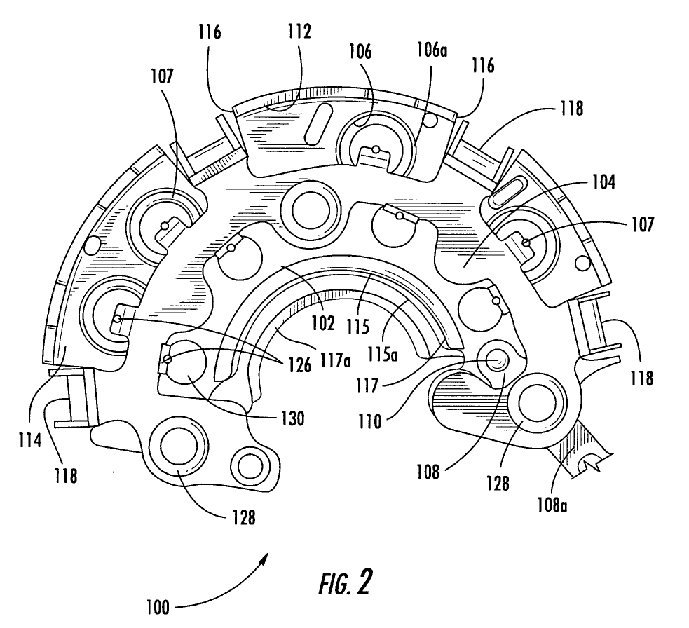

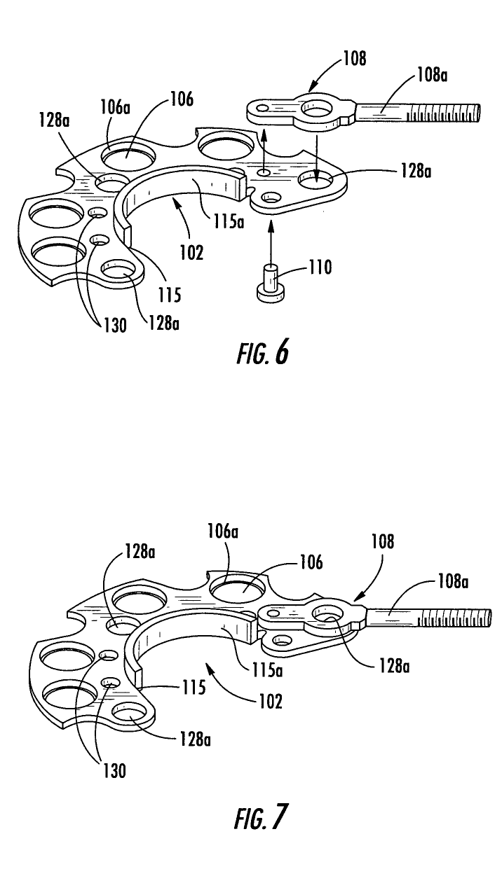

FIG. 2 is a plan view of the rectifier 100 of the present invention looking in the direction of the positive heat sink 102 and the lead frame 104 formed of an insulator material and mounted on the positive heat sink. FIGS. 6 and 7 are respective exploded isometric and assembled isometric views of the positive heat sink 102 shown in FIG. 2 without showing a mounting flange as described below. The heat sink 102 is formed of a copper plate material and has a thickness less than 5 millimeters and typically about 1-3 millimeters. In one aspect of the present invention, the heat sink is about 1.7 to about 2.5 millimeters thick, and closer to about 2.0 millimeters thick. It has four diode openings 106 that are dimensioned for receiving four positive diodes 107 in a pressed fit. The pressed fit diodes 107 are secured in a more rigid manner in this thin heat sink 102 by a strengthened annular shoulder 106a formed around each diode opening 106. This shoulder 106a provides an added advantage when the alternator is under heavy loads and much heat is generated. A terminal bolt assembly includes a terminal bolt 108a and 108 is connected to the positive heat sink and retained by a rivet 110 as shown in FIG. 6.

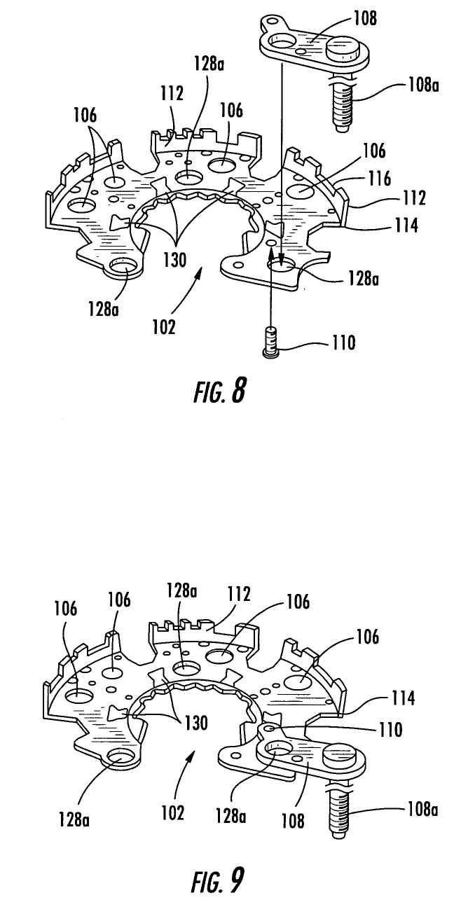

The heat sink 102 and rectifier 100 are substantially semicircular configured. The lead frame 104 is also semicircular configured and extends along a medial section of the heat sink 102, which also includes a mounting flange 112 formed along the outer, arcuate edge 114. Cut-outs 116 expose input terminals 118 on the lead frame 104 for connection to a Y-connected stator coil. Although a horizontal terminal bolt assembly 108 is illustrated in FIGS. 2, 6 and 7, the terminal bolt assembly could be formed vertical as shown in FIGS. 8 and 9. An inner, arcuate edge 115 on the positive heat sink could also include an inner mounting flange 115a.

FIG. 3 is a plan view of the rectifier 100 of the present invention looking in the direction of the negative heat sink 120 that is configured to be secured to a rear cover 12 of the alternator, such as described with reference to FIG. 1. The negative heat sink 120 includes four diode openings 122 that receive negative pressed fit diodes 124. The negative heat sink 120, similar to the positive heat sink 102, is formed of a copper plate material and is substantially semicircular configured. As shown in FIG. 3, the negative heat sink 120 has less surface area than the positive heat sink, exposing the positive diodes 107, which are pressed fit in diode openings 106 located adjacent the outer arcuate edge 114. An outer arcuate edge on the negative heat sink is planar configured. An inner arcuate edge 117 on the negative heat sink (FIG. 3) could include an inner mounting flange 117a, which is set inward greater than the inner mounting flange 115a on the positive heat sink.

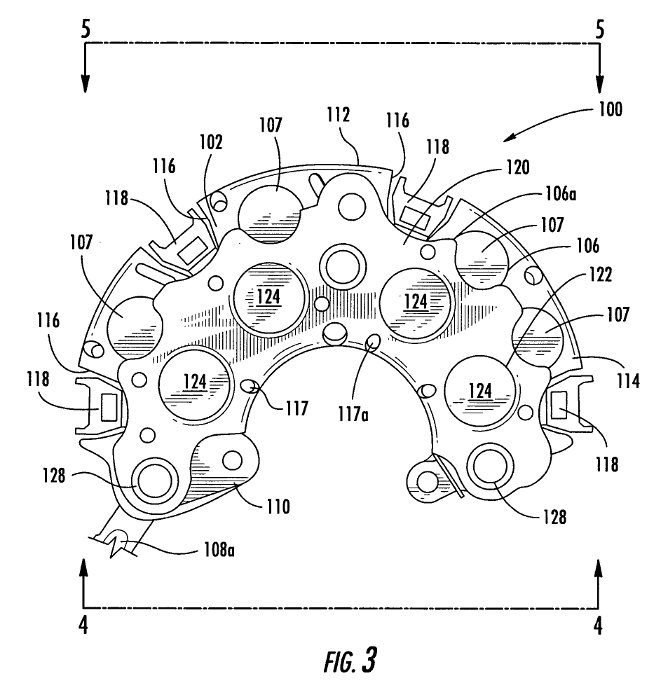

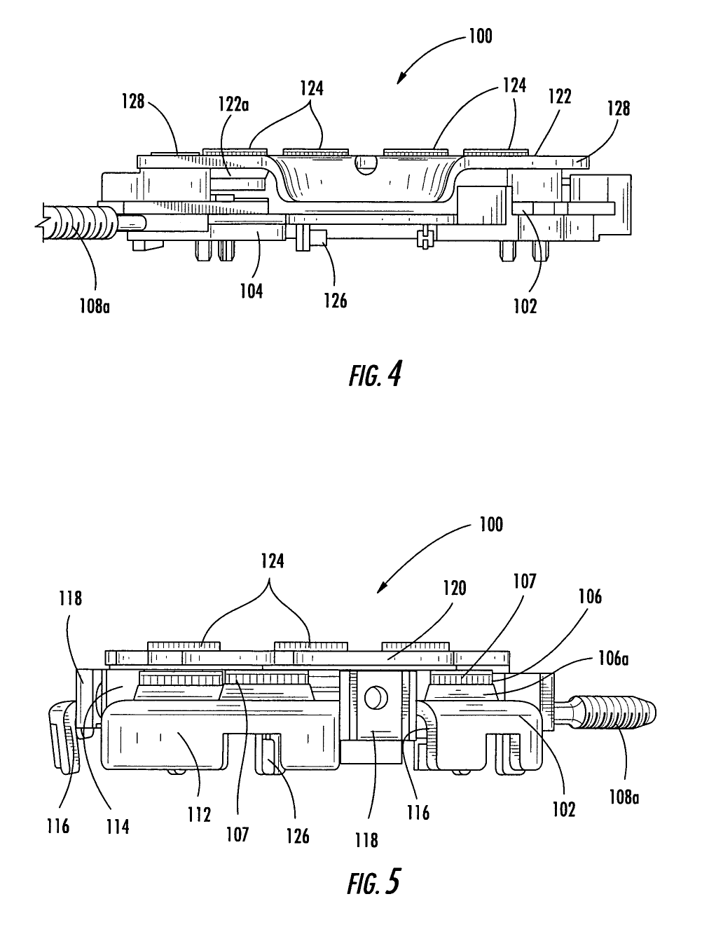

To secure the pressed fit diodes in a more rigid manner using the thin heat sink material, as with the positive heat sink 102, an annular shoulder 122a is formed around each diode opening as shown in FIGS. 4 and 5. Thus, the pressed fit diodes can be secured more rigidly even when using thin heat sink material as described, thus adding to the strength of the pressed fit diodes relative to the heat sink even under high heat and stressed vehicle operating conditions. The annular shoulders 102a, 122a could be formed after initially stamping the heat sinks in a manufacturing process by inserting with force a punch or similar forming tool into the diode opening and forming a radius along a formed shoulder.

The lead frame 104 is mounted on the positive heat sink 102 opposing the negative heat sink 120 such that the lead frame is positioned on the outside of the rectifier 100 instead of interposed between heat sinks as in other rectifier designs that sometimes use pressed fit diodes. The lead frame 104 includes embedded conductors and connectors 126 that interconnect the diode leads of the rectifier diodes in an electrical rectifying configuration. The input terminals 118 extend outward from the lead frame into the cut-outs 116 for connecting to outputs of the stator coil. The heat sinks 102, 120 and lead frame 104 are secured together by insulated rivets 128, which receive bolts fixed on the alternator as described before. The insulated rivets are received in rivet receiving openings 128a (FIGS. 6-9) formed in both positive and negative heat sinks.

The diodes that are pressed fit into the diode openings could be formed in a manner as disclosed in commonly assigned U.S. Ser. No. 09/928,974, titled “Method For Manufacturing Diode Subassemblies Used in Rectifier Assemblies of Engine Driven Alternate of Generators,” the disclosure which is hereby incorporated by reference in its entirety. The diode includes a lower diode cup having a circular configuration. Usually the interior portion of the diode cup includes a raised, annular die mount and a lower edge portion of the diode cup has serrations to allow a pressed fit within a close tolerance opening of the heat sink of the rectifier. The diode cup can be formed as a copper cup that is nickel plated. A semiconductor diode die can be reflow soldered with solder preforms into the diode cup. A stand-up diode lead rests on the solder preform and an epoxy layer can be used as a sealant. A diode lead includes a stem and circular base and polarity of the semiconductor diode die can be confirmed during the manufacturing process such that the flat underside of the diode cup could correspond to a cathode and the stem correspond as an annode.

When the negative heat sink is secured to the positive heat sink in this rectifier design, the diodes are pressed fit in both heat sinks to face the same direction, as shown in FIG. 2. Diode leads from the negative diodes extend up through lead openings 130 formed in the positive heat sink. FIG. 6 illustrates four diode lead openings 130 as circular openings formed in the positive heat sink. Diode leads from the negative diodes extend through these openings 130 to be interconnected to proper connectors 126 on the lead frame.

In the embodiment shown in FIGS. 8 and 9, the lead openings 130 are formed as angled cut-outs. This configuration of the positive heat sink shown in FIGS. 8 and 9 is different than previously shown in FIGS. 6 and 7 to allow the vertical bolt design to fit within the mounting area on the rear housing member.

The rectifier 100 of the present invention can be manufactured by first forming positive and negative heat sinks 102, 120 at the required thickness, such as by stamping copper plate into the desired configuration. Diode openings are also stamped or drilled and the annular shoulder formed around each diode opening using a punch or other forming means. The mounting flange is formed along the circumferential, arcuate edge of the positive heat sink. Cut-outs are formed on the mounting flange (sometimes before bending the mounting flange into its angled position, for example, during the stamping operation. The cut-outs will expose any input terminals for connection to a stator coil when the lead frame is interconnected and secured to the positive and negative heat sinks.

The rectifier diodes are pressed fit into the openings and insulated rivets are preferably used to interconnect and secure together the positive and negative heat sinks and the lead frame. The diode leads are soldered to the appropriate terminals of the lead frame and any excess diode leads cut.

The present invention advantageously provides a rectifier for a vehicle alternator, such as a Nippondenso alternator having thin heat sinks and outer lead frame, and designed for minimal space constraints. The rectifier can withstand greater stresses and heat by using rectifier diodes pressed fit within respective diode openings of negative and positive heat sinks. Because these types of rectifiers and heat sinks were considered to have been too thin for use with press fit diodes, the present invention is an advantageous improvement over the prior art. This novel and unobvious contribution solves many prior art problems associated with Nippondenso vehicle and similarly designed vehicle alternators when used in high heat and stressed vehicle applications.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed is:

1. A rectifier for a vehicle alternator comprising:
a negative heat sink having a thickness less than 5 mm and having a plurality of diode openings;
a positive heat sink having a thickness less than 5 mm and having a plurality of diode openings and mounted in parallel, spaced relation to the negative heat sink;
rectifier diodes pressed fit within respective diode openings of negative and positive heat sinks; and
a lead frame formed of an insulator material and mounted on the positive heat sink opposite the negative heat sink and having embedded conductors and connectors that interconnect rectifier diodes in an electrical rectifying configuration.

2. A rectifier according to claim 1, and further comprising an annular shoulder formed around each diode opening for supporting a rectifier diode in a pressed fit within a respective diode opening.

3. A rectifier according to claim 1, and further comprising a terminal bolt connected to said positive heat sink.

4. A rectifier according to claim 1, and further comprising a plurality of input terminals adapted to be connected to a stator coil.

5. A rectifier according to claim 4, wherein said positive heat sink includes an arcuate edge and a mounting flange along said edge and having cutouts for exposing the input terminals for connection to a stator coil.

6. A rectifier according to claim 4, wherein the input terminals are formed integral with said lead frame.

7. A rectifier according to claim 1, wherein said heat sinks are substantially semicircular configured.

8. A rectifier according to claim 1, wherein said heat sinks are formed of copper and have a thickness ranging from about 1 mm to about 3 mm.

9. A rectifier according to claim 1, and further comprising a plurality of insulated rivets securing the heat sinks and lead frame together and separating the heat sinks from each other.

10. A rectifier according to claim 1, wherein said positive heat sink has a greater surface area than said negative heat sink for exposing the rectifier diodes that are pressed fit within the diode openings of the positive heat sink.

11. A vehicle alternator comprising:
front and rear housing members;
a Y-connected stator coil and rotor supported by said front and rear housing members;
a rear cover that connects to the rear housing member; and
a brush holder and rectifier disposed on the rear housing member and interposed between the rear housing member and rear cover, said rectifier operatively connected to said Y-connected stator coil, and comprising
a negative heat sink having a plurality of diode openings;
a positive heat sink having a plurality of diode openings and mounted in parallel, spaced relation to the negative heat sink;
rectifier diodes pressed fit within respective diode openings; and
a lead frame formed of an insulator material and mounted on the positive heat sink opposite the negative heat sink and having embedded conductors and connectors that interconnect rectifier diodes in an electrical rectifying configuration.

12. A vehicle alternator according to claim 11, and further comprising an annular shoulder formed around each diode opening for supporting a rectifier diode in a pressed fit within a respective diode opening.

13. A vehicle alternator according to claim 11, and further comprising a terminal bolt connected to said positive heat sink.

14. A vehicle alternator according to claim 11, and further comprising a plurality of input terminals on the lead frame and connected to the Y-connected stator coil.

15. A vehicle alternator according to claim 14, wherein said positive heat sink includes an arcuate edge and a mounting flange along said edge and having cutouts for exposing the input terminals for connection to a stator coil.

16. A vehicle alternator according to claim 14, wherein the input terminals are formed integral with said lead frame.

17. A vehicle alternator according to claim 11, wherein said heat sinks are substantially semicircular configured.

18. A vehicle alternator according to claim 11, wherein said heat sinks have a thickness less than 5 mm.

19. A vehicle alternator according to claim 18, wherein said heat sinks are formed of copper and have a thickness ranging from about 1 mm to about 3 mm.

20. A vehicle alternator according to claim 11, and further comprising a plurality of insulated rivets securing the heat sinks and lead frame together and separating the heat sinks from each other.

21. A vehicle alternator according to claim 11, wherein said positive heat sink for exposing the rectifier diodes that are pressed fit within the diode openings of the positive heat sink.

22. A vehicle alternator according to claim 11, wherein said alternator comprises a Nippondenso alternator.

23. A method of forming a rectifier used for a vehicle alternator comprising:
forming positive and negative heat sinks having a thickness less than 5 mm;
forming diode openings within each of the positive and negative heat sinks;
press fitting rectifier diodes within respective diode openings;
mounting a lead frame having embedded conductors and connectors on the positive heat sink opposite the negative heat sink and securing the lead frame and heat sinks together such that the heat sinks are spaced in substantially parallel, spaced relation to each other; and
interconnecting the diodes to connectors on the lead frame such that the rectifier diodes are configured in an electrically rectifying configuration.

24. A method according to claim 23, and further comprising the step of forming a shoulder around each diode opening for supporting the rectifier in a pressed fit within the diode opening.

25. A method according to claim 23, and further comprising the step of connecting a terminal bolt to the positive heat sink for connection to a vehicle alternator.

26. A method according to claim 23, and further comprising the step of securing the lead frame and heat sinks together by insulated rivets.

27. A method according to claim 23, and further comprising the step of forming input terminals that are adapted to be connected to a stator coil of a vehicle alternator.

28. A method according to claim 23, and further comprising the step of configuring the connectors on the lead frame to be connected to a Y-connected stator coil of a vehicle alternator.

29. A method according to claim 23, and further comprising the step of forming a mounting flange along an arcuate edge of the positive heat sink and forming cutouts on the mounting flange for exposing input terminals on the lead frame for connection to a stator coil.

30. A method according to claim 29, and further comprising the step of forming the input terminals integral with the lead frame.

31. A method according to claim 23, and further comprising the step of forming the heat sinks to a thickness of about 1 mm to about 3 mm.

32. A method according to claim 23, and further comprising the step of forming the heat sinks in a substantially semicircular configuration.

33. A method according to claim 23, and further comprising the step of forming the positive heat sink with a greater surface area than the negative heat sink for exposing the rectifier diodes on the positive heat sink when the heat sinks are secured together.
